(19) United States
(12) Patent Application Publication
(10) Pub. No.: US 2026/0176971 A1
(43) Pub. Date: Jun. 25, 2026

(54) ROTOR-STATOR ASSEMBLY FOR A ROTARY ENGINE, COMPRESSOR OR PUMP, A ROTARY ENGINE AND A LIFTING UNIT AND DEVICE

(71) Applicants: Eirini Stassinopoulou, Glyfada (GR); Eleni Stassinopoulou, Glyfada (GR)

(72) Inventor: George STASSINOPOULOS, Glyfada (GR)

(73) Assignees: Eirini Stassinopoulou, Glyfada (GR); Eleni Stassinopoulou, Glyfada (GR)

(21) Appl. No.: 19/312,909

(22) Filed: Aug. 28, 2025

(30) Foreign Application Priority Data
Dec. 30, 2024 (EP) 24223625.5

(51) Int. Cl. F01C 11/00; F04C 2/22

(52) U.S. Cl. CPC F01C 11/008; F04C 2/22

(57) ABSTRACT

A rotor-stator assembly for a rotary engine, compressor or pump, includes a rotor arranged to rotate eccentrically in a stator chamber, the geometry of the rotor being configured to provide a first fluid seal at a region of maximum proximity between the outer peripheral surface of the rotor and the inner peripheral wall of the stator chamber. A second fluid seal is provided by means of a component rotating with the rotor, one end of which is permanently connected to the inner surface of the stator chamber by means of bearings and slides along the inner surface of the stator chamber, and the other end of which is accommodated in a radially movable manner in a receptacle of the rotor, the first and second fluid seals delimiting a first chamber portion and a second chamber portion of the stator chamber.

### RELATED APPLICATIONS

This application claims the benefit of and right of priority under 35 U.S.C. § 119 to European Patent Application no. EP24223625.5, filed on 30 Dec. 2024, the contents of which are incorporated herein by reference in its entirety.

### FIELD OF THE DISCLOSURE

The invention relates to the field of rotary piston arrangements for rotary engines, compressors or pumps. In particular the invention relates to rotor-stator assembly for a rotary engine, compressor or pump and to a rotary engine comprising two rotor-stator assemblies according to the invention. Moreover, the invention relates to a lifting unit and device comprising rotor-stator assemblies according to the invention.

### BACKGROUND

Rotary engines are well known and have been developed in various configurations, the most famous of which is the Wankel engine. Common to all rotary engines is the provision of two or more variable-volume chambers formed between a rotor and the walls of the stator chamber in which the rotor rotates. The volume of each chamber varies as the rotor rotates in the stator. The Wankel design defines three chambers, isolated from each other by the contact between the triangular rotor's three apexes and the oval chamber wall. All phases of the four-stroke engine cycle are implemented by the three variable-volume chambers. Disadvantages of the Wankel rotor design are its complex eccentric rotor bearing and the continuous lateral displacement of the rotor mass, which expends energy and promotes wear and vibration. Other rotary piston arrangements have been proposed with a view to providing rotary engines with simpler, balanced rotor construction and improved performance.

U.S. Pat. No. 4,638,776 describes a twin-rotor engine which has two cooperating rotors arranged adjacent to each other and communicating via a connecting channel. The first eccentric rotor rotates inside a first (compression) chamber so as to draw in a fuel/air mixture during a first part of the cycle (intake) and then compresses the mixture during a second part of the cycle (compression). The compressed mixture is then expelled into a second (combustion) rotor chamber via the connecting channel, whereupon the mixture is detonated in a third part of the cycle (power) and then expelled through an exhaust port in a fourth part of the cycle (exhaust). The rotors according to U.S. Pat. No. 4,638,776 are equipped with radial vanes providing a low-friction seal between the rotor and the stator (chamber). These vanes are arranged to move radially outward and inward from the rotor, synchronized with the eccentric motion of the rotor, so as to maintain a small but constant gap distance between the vane tip and the inner peripheral wall of the chamber.

This vane is moved in and out by a pin which engages in a circular slot in the side wall of the chamber. This vane drive arrangement is subject to wear, and is difficult to access for adjustment and repair. Furthermore, the vane and the drive arrangement embody an eccentric and radially-mobile mass and exert radial forces on the rotor which are complicated to compensate and contribute to an imbalance in the rotor.

WO 2018/146333 A1 discloses a rotor-stator assembly for a rotary engine, compressor or pump, comprising a rotor arranged to rotate eccentrically in a stator chamber and a radiallymobile first vane for providing a first fluid seal between an outer peripheral surface of the rotor and an inner peripheral wall of the stator chamber, and a second fluid seal at a region of maximum proximity between the outer peripheral surface of the rotor and the inner peripheral wall of the stator chamber, such that the first and second fluid seals delimit at least a first chamber portion and a second chamber portion of the stator chamber, and a vane actuator configured for moving the first vane radially inwards and outwards such that the radial motion of the first vane follows the eccentric rotary motion of the outer peripheral surface of the first rotor whereby the first vane is substantially rotationally static with respect to the stator chamber. According to WO 2018/146333 A1 the vane actuator is configured to support the vane with a first vane seal gap between the first vane and the peripheral outer surface of the rotor. The provision of the vane actuator results in a complex structure of the rotor-stator assembly.

### SUMMARY

The present invention aims to overcome at least some of the above disadvantages of prior art engines such as the engines described above. To this end, the invention foresees a rotor-stator assembly for a rotary engine as described in claim 1. Further embodiments of the invention are set out in the dependent claims. As a result, a rotor-stator assembly is presented which is simpler, lighter and better balanced compared with the prior art assemblies. Besides that, it also permits easier access for maintenance, adjustment and repair of the assembly. Moreover, the invention aims to present a lifting unit and device based on a rotor-stator assembly as presented herewith.

According to the invention a rotor-stator assembly for a rotary engine, compressor or pump, comprises a rotor arranged to rotate eccentrically in a stator chamber, the geometry of the rotor being configured to provide a first fluid seal at a region of maximum proximity between the outer peripheral surface of the rotor and the inner peripheral wall of the stator chamber, whereby a second fluid seal is provided by means of a component rotating with the rotor, one end of which is permanently connected to the inner surface of the stator chamber by means of bearings and slides along the inner surface of the stator chamber, and the other end of which is accommodated in a radially movable manner in a receptacle of the rotor, the first and second fluid seals delimiting a first chamber portion and a second chamber portion of the stator chamber. For example, the component can be connected from both its sides viewed axially to one vertical wreath respectively, the wreaths being configured to rotate by ball bearings on either inner side of the stator chamber.

Air and gas leakage can be controlled by sealing rings placed in grooves on the wreaths' outer diameter in case the component is connected from both its sides viewed axially to one vertical wreath respectively, the wreaths being configured to rotate by ball bearings on either inner side of each stator chamber.

The component can also be slidingly connected to at least two ball bearing rims provided on the inner surface of the stator chamber, whereby a sealing lip is arranged at the end of the component facing the inner surface of the stator chamber.

In addition, in order to optimize sealing small rectangular shaped bars with springs can be arranged at the end of the component facing the inner surface of the stator chamber. Moreover, the rotating flat parts can hinder air and gas leakage by providing a light touch between them. In addition, during rotation there where rotor's outside diameter overruns stator chamber's inner diameter, irregularly by 1.5 m/m, air and gas leakage can be hindered by the creation of an arch between their diameters.

Within the framework of the present application a rotor engine is proposed, which comprises a first rotor-stator assembly according to the invention, configured such that its first chamber portion is for performing an intake part of a four-stroke engine cycle, and its second chamber portion is for performing a compression part of the four-stroke engine cycle, and a second rotor-stator assembly according to the invention, configured such that its first chamber portion is for performing a detonation part of a four-stroke engine cycle, and its second chamber portion is for performing an exhaust part of the four-stroke engine cycle.

The rotor engine also comprises a connecting fluid channel for conveying compressed air from the second chamber portion of the first rotor-stator assembly into the first chamber portion of the second rotor-stator assembly and a rotary disc valve for opening or blocking the connecting fluid channel at predetermined parts of the engine cycle, whereby the disc valve and the rotors of the first and second rotor - stator assemblies are mounted on a common main shaft.

Around both stator chambers ample space for enabling the engine's cooling van be provided.

The lifting device according to the present invention comprises a lifting unit whose design corresponds to the design of the rotor engine as presented herewith, with the difference that the first and second rotor-stator

assemblies are differently dimensioned, the lifting unit being driven preferably by a rotor engine according to the invention, the lifting unit and the rotor engine rotating together by a common shaft.

Thus a lifting unit comprises a first and a second rotor-stator assembly according to the invention, the rotors thereof being mounted on a common main shaft and arranged to rotate eccentrically each in a stator chamber, whereby the stator chambers of the first and second rotor-stator assembly are coaxial to each other and connected for fluid communication by means of a connecting fluid channel built by two respective openings of the stator chambers, the connecting fluid channel being opened and closed by an opening in a valve disc located between the first and the second rotor-stator assembly and arranged to rotate with the main shaft. The air flow compared to the rotor engine is inverted, so that that air flows from the second rotor-stator assembly to the first rotor-stator assembly, the stator chamber of the second rotor-stator assembly having a larger volume than the stator chamber of the first rotor-stator assembly. According to other embodiments the lifting unit can be driven by other types of engines, e.g. by an electric motor.

The second rotor-stator assembly of a lifting unit is driven by an engine, preferably by a rotor engine according to the invention and is used for air intake into the first chamber portion thereof from an air inlet, and for compressing this amount of air, the compressed air being transferred from the second chamber portion thereof to the first chamber portion of the first rotor-stator assembly through the connecting fluid channel and the rotary disc valve when the openings coincide, when the lifting device is in motion. Then, the air is pushed from the second chamber portion of the first rotor-stator assembly by the rotating rotor at a suitable revolution rate of e.g. 50 Revs/sec or more through an outlet preferably at 5 or more atmospheres depending on the configuration of the device.

The lifting units operate in the way the four-cycle rotor engine operates, whereby the air flow is inverted compared to rotor engine disclosed herein. A lifting device for weights can e.g. comprise four lifting devices according to the invention placed in each corner of a rectangle shape. According to a further development of the invention, if more such lifting devices are placed on both sides of a rectangular shaped form, then such a form can fly.

### BRIEF DESCRIPTION OF THE DRAWINGS

The invention will be described in detail with reference to the attached figures, in which:

FIG. 1 shows in cross-section, an example of a rotor engine according to the present invention, comprising two rotor-stator assemblies according to the invention;

FIG. 2 shows in cross-section, in the plane B-B indicated in FIG. 1, a first rotor-stator assembly according to FIG. 1 configured such that its first chamber portion is for performing an intake part of a four-stroke engine cycle, and its second chamber portion is for performing a compression part of the four-stroke engine cycle of the rotor engine, at the begin of one revolution of the rotor engine and thus at the begin of the compression process;

FIG. 3 shows in cross-section, in the plane B-B indicated in FIG. 1, the first rotor-stator assembly according to FIG. 2 at the stage where

the compression in the second chamber portion of the first rotor-stator assembly during revolution has reached a maximal predetermined value; FIG. 4 shows in cross-section, in the plane C-C indicated in FIG. 1 the rotor engine according to FIG. 1;

FIG. 5 shows in cross-section, in the plane D-D indicated in FIG. 1, a second rotor-stator assembly according to FIG. 1 configured such that its first chamber portion is for performing a detonation part of a four-stroke engine cycle, and its second chamber portion is for performing an exhaust part of the four-stroke engine cycle, at the stage the compressed fuel-air mixture in the first chamber portion of the second rotor-stator assembly is detonated;

FIG. 6 shows in cross-section, in the plane D-D indicated in FIG. 1, the second rotor-stator assembly according to FIG. 5 at a stage after the detonation;

FIG. 7 shows in cross-section, in the plane D-D indicated in FIG. 1, the second rotor-stator assembly according to FIG. 5 at another stage after the detonation;

FIG. 8 shows in cross-section an example of a lifting unit according to the present invention, comprising two differently dimensioned rotor-stator assemblies according to the invention;

FIG. 9 shows in cross-section, in the plane F-F indicated in FIG. 8, a second rotor-stator assembly according to FIG. 8 configured such that its first chamber portion is for performing an intake step of air, and its second chamber portion is for performing a compression step of the air, at the begin of one revolution of the lifting unit and thus at the begin of the compression process, the second rotor stator assembly being driven by a not shown rotor engine;

FIG. 10 shows in cross-section, in the plane F-F indicated in FIG. 8, the second rotor-stator assembly according to FIG. 8 at the stage where the compression in the second chamber portion of the second rotor-stator assembly during revolution has reached a maximal predetermined value;

FIG. 11 shows in cross-section, in the plane G-G indicated in FIG. 8 the lifting unit according to FIG. 8;

FIG. 12 shows in cross-section, in the plane H-H indicated in FIG. 8, the first rotor-stator assembly according to FIG. 8 configured such that its first chamber portion is for performing a an intake step of the compressed air from the second rotor-stator assembly, and its second chamber portion is for performing an exhaust part of the air with high pressure, at the stage the compressed air is pushed out from the lifting unit;

FIG. 13 shows in cross-section, in the plane H-H indicated in FIG. 8, the first rotor-stator assembly according to FIG. 8 at a stage where compressed air from the second rotor-stator-assembly is transferred to the first chamber portion; and

FIG. 14 shows in cross-section a lifting device comprising a lifting unit being driven by a rotor engine according to the invention, the lifting unit and the rotor engine rotating together by a common shaft.

The figures are provided merely as an example and aid to understanding the principles underlying the invention and should not be taken as limiting the scope of protection sought. Where the same reference numbers are used in different figures, these are intended to indicate similar or equivalent features. It should not be assumed, however, that the use of different reference numbers is intended to indicate any particular degree of difference between the features to which they refer. Not all reference numbers are included in every figure for the sake of clarity and readability of the figures.

### DETAILED DESCRIPTION

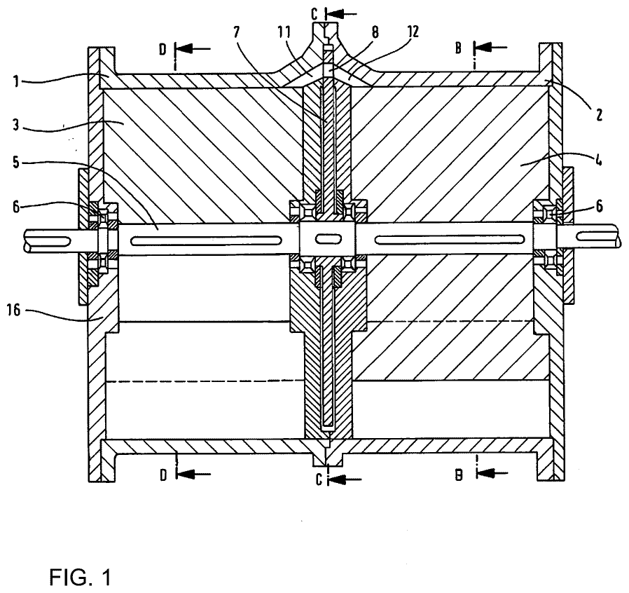

According to the invention and with reference to FIGS. 1 and 4 a rotor engine according to the present invention comprises a first and a second rotor-stator assembly, the rotors 4, 3 thereof being mounted on a common main shaft 5 and arranged to rotate eccentrically each in a stator chamber 2, 1, whereby the stator chambers 2, 1 are coaxial to each other and connected for fluid communication by means of a connecting fluid channel built by two respective openings 11, 12 of the stator chambers 1,2, the connecting fluid channel being opened and closed by an opening 8 in a valve disc 7 located between the two assemblies and arranged to rotate with the main shaft 5. The roller bearings 6 needed for engine's operation are situated on the four inner sides of the stator chambers 1, 2, whereby eccentric rotary guides 16 are used for guiding the volume separator during rotation. In the following description, the first rotor-stator assembly comprises rotor 4 and stator chamber 2, whereas the second rotor-stator assembly comprises rotor 3 and stator chamber 1.

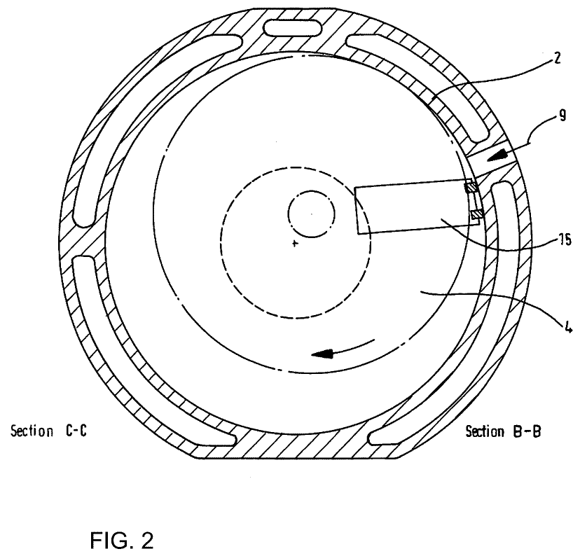

According to the invention, and referring to FIGS. 1 and 2 the rotors 3, 4 are configured to provide a first fluid seal at a region of maximum proximity between the outer peripheral surface of the rotor 3, 4 and the inner peripheral wall of the respective stator chamber 1, 2, whereby a second fluid seal is provided by means of a component 15 rotating with each rotor 3, 4, one end of which is permanently connected to the inner surface of the respective stator chamber 1, 2 preferably by means of bearings and slides along the inner surface of the stator chamber, and the other end of which is accommodated in a radially movable manner in a receptacle of the respective rotor 3, 4, the first and second fluid seals delimiting a first chamber portion and a second chamber portion of each stator chamber 1, 2. Preferably, the component 15 can be connected from both its sides viewed axially to one vertical wreath respectively, the wreaths being configured to rotate by ball bearings on either inner side of each stator chamber 1, 2. By this embodiment during a 360 rotation of the rotor, the volumes of the two chamber portions of a rotor-stator assembly, reach the same maximum and minimum value, respectively.

The rotors 3, 4 are preferably shaped such that their center of gravity coincides with the axis of the main shaft. This may be achieved by machining one or more hollow regions in the rotors, for example.

According to the invention the first rotor-stator assembly is configured such that its first chamber portion is for performing an intake part of a four-stroke engine cycle, and its second chamber portion is for performing a compression part of the four-stroke engine cycle. Moreover, the second rotor-stator assembly according to the invention is configured such that its first chamber portion is for performing a detonation part of a four-stroke engine cycle, and its second chamber portion is for performing an exhaust part of the four-stroke engine cycle. By the system according to the invention simultaneously four alternated volumes are formed, enabling the four-cycle application to be effective in one revolution.

In order to achieve the operation of a four-stroke engine cycle that the volumes of the first and second chamber portions of the second rotor-stator assembly vary inversely with respect to their counterpart first and second chamber portions of the first rotor-stator assembly. According to the invention the rotor of the second rotor-stator assembly and thus the component 15 leads the rotor of the first rotor-stator assembly and thus the component 15 thereof by an offset angle of approximately 90°, whereby the valve disc opens the connecting fluid channel between the first and the second stator chamber when the compression in the second chamber portion of the first rotor-stator assembly has reached the maximum value.

The mode of operation of the rotor engine according to the invention is explained as follows with reference to the FIGS. 2, 3, 4, 5, 6, and 7.

FIG. 2 shows the first rotor-stator assembly of a rotor engine at the beginning of one revolution of the rotor engine and thus at the beginning of the compression process. The first chamber portion of the first rotor-stator assembly which serves as the air-intake volume, has a minimal volume, whereby as the rotor 4 rotates in the direction of the arrow, the increasing volume of the first chamber portion draws air in through an air intake channel 9 provided in the stator chamber 2. At the same time, air drawn in during the previous revolution is being compressed in the second chamber portion of the first rotor-stator assembly by the rotation of the rotor 4 and the component 15.

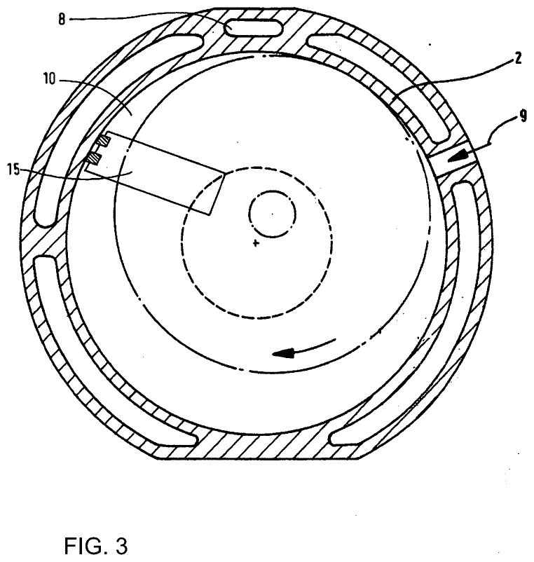

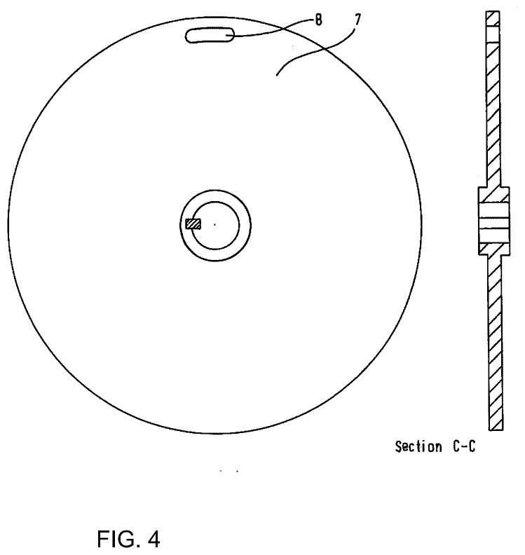

FIG. 3 shows the first rotor-stator assembly according to FIG. 2 at the stage where the compression in the second chamber portion 10 of the first rotor-stator assembly during revolution has reached a maximal predetermined value e.g. 7 or 8 atmospheres, this air being ready to be transferred to the second rotor-stator assembly for detonation.

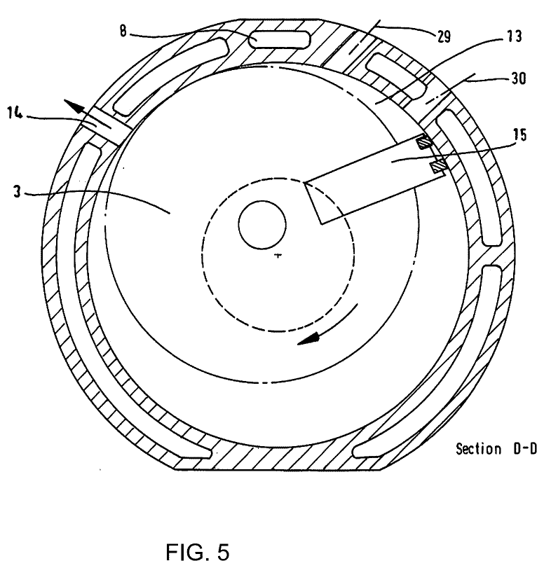

When the volume of the second chamber portion of the first rotor-stator assembly reaches a predetermined minimal value and thus a predetermined maximal compression, e.g. 7 or 8 atmospheres, is reached, the connecting fluid channel built by the two respective openings 11, 12 of the rotor-stator assemblies is opened by the valve disc 7. This means referring to FIG. 4 that the opening 8 in the valve disc 7 coincides with the connecting fluid channel, so that the compressed air passes through the connecting fluid channel to the first chamber portion of the second rotor-stator assembly, which serves as a combustion chamber and subsequently, when the connecting fluid channel is closed by the valve disc 7 due to the rotation thereof fuel is sprayed or misted into the airflow by means of a at least one nozzle 29 shown in FIG. 5.

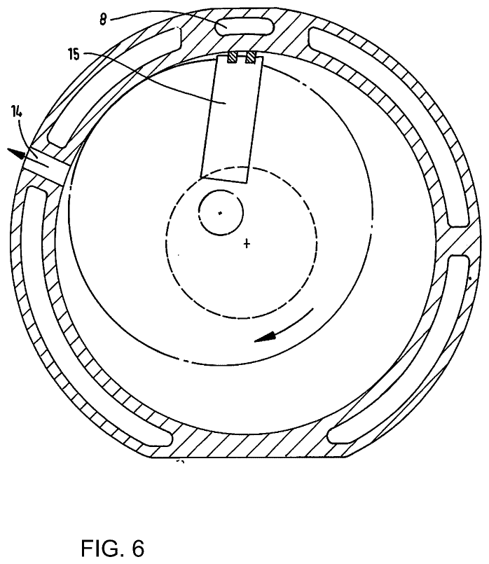

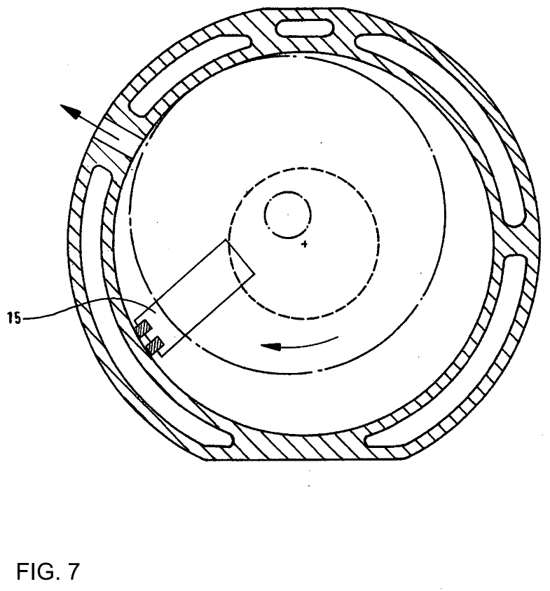

Subsequently and referring to FIGS. 6 and 7 when the combustion chamber has reached a predetermined volume due to the rotation of the rotor 3 the compressed fuel-air mixture in the first chamber portion 13 of the second rotor-stator assembly is detonated by an ignition spark or other suitable means 30, thereby providing drive force on the rotor 3 of the second rotor-stator assembly and thus on the common main shaft 5. Meanwhile, the second chamber portion of the second rotor-stator assembly contains the exhaust gases from the previous detonation, which are then expelled through an exhaust channel 14 as the volume of the second chamber portion is reduced.

Thus, after a complete revolution of the rotors a four-stroke engine cycle is completed.

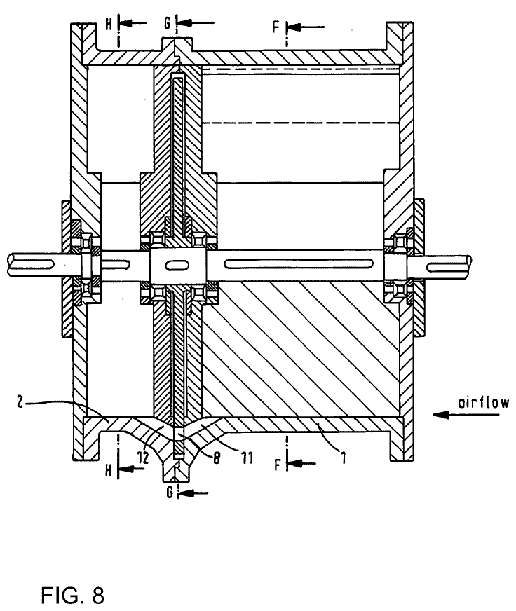

FIG. 8 shows in cross-section an example of a lifting unit according to the present invention, which comprises two differently dimensioned rotor-stator assemblies according to the invention. The design of the lifting unit corresponds to the design of the rotor engine as presented herewith as can be taken from FIG. 8, with the difference that the first and second rotor-stator assemblies are differently dimensioned, and that the air flow compared to the rotor engine is inverted, so that that air flows from the second rotor-stator assembly to the first rotor-stator assembly, the second rotor-stator assembly and this the lifting unit being driven by an engine, preferably by a rotor engine according to the invention, the lifting unit and the rotor engine rotating together by a common shaft and the stator chamber of the second rotor-stator assembly having a larger volume than the stator chamber of the first rotor-stator assembly. Since the components of the rotor engine have been disclosed and explained within the framework of this description, only the differences between the rotor engine and the lifting unit will be explained in the following.

The large second rotor-stator assembly of a lifting unit is preferably driven by a rotor engine according to the invention and is used for air intake from an air inlet, and for compressing this amount of air, the compressed air being transferred to the small first rotor-stator assembly through the connecting fluid channel and the rotary disc valve when the openings coincide, when the lifting device is in motion. Then, the air is pushed from the small rotor-stator assembly by the rotating rotor at a suitable revolution rate of e.g. 50 Revs/sec or more through an outlet at 5 or more atmospheres depending on the configuration of the lifting unit.

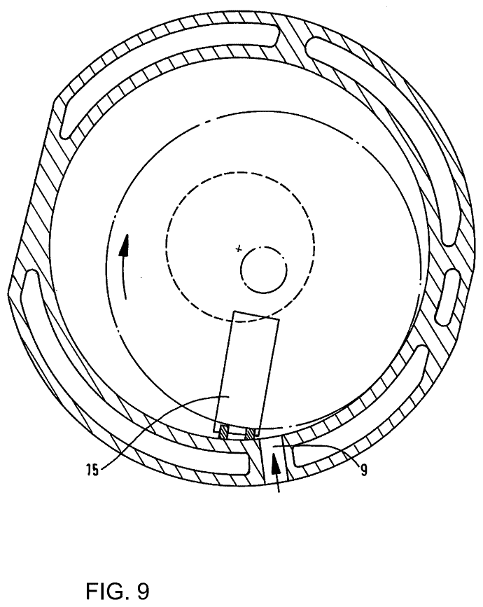

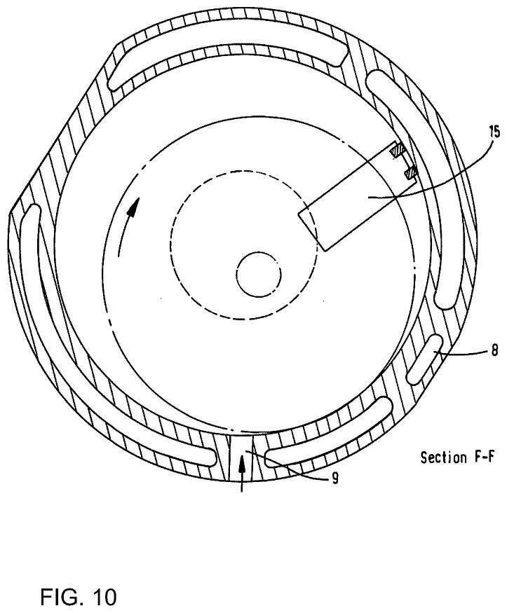

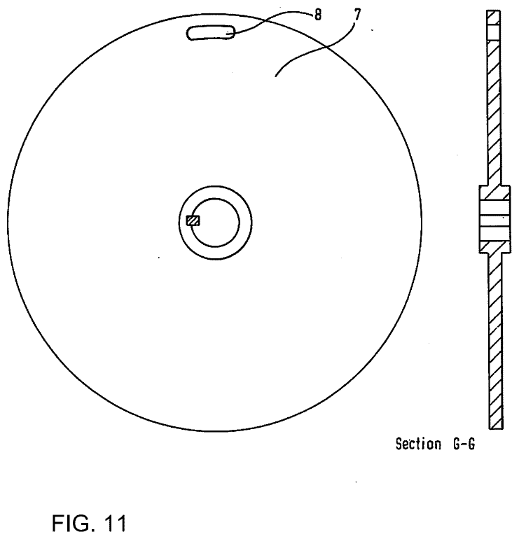

The second rotor-stator assembly comprising a stator and a rotor is used for air intake from an air inlet 9 shown in FIGS. 9 and 10, and compressing this amount of air simultaneously, the compressed air being transferred to the small first rotor-stator assembly through the connecting fluid channel built by the two respective openings 11, 12 of the stator chambers 1,2 which is opened by the valve disc 7. This means referring to FIG. 11 that the opening 8 in the valve disc 7 coincides with the connecting fluid channel, so that the compressed air passes through the connecting fluid channel to the first chamber portion of the first rotor-stator assembly.

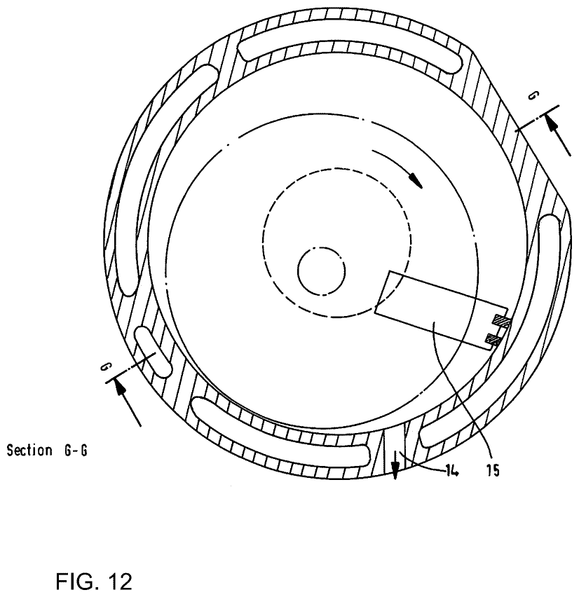

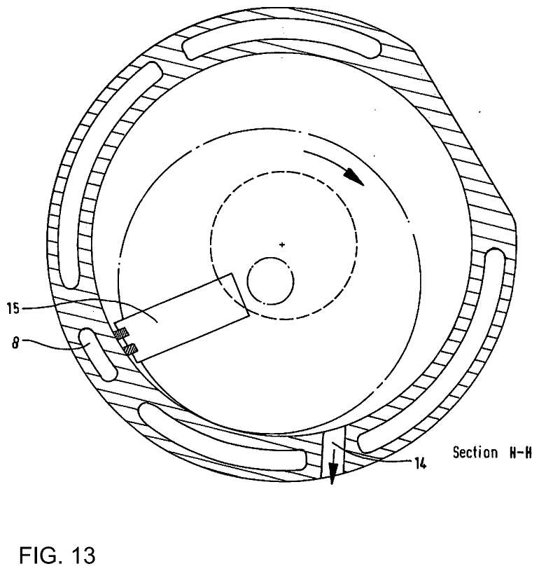

Then during the motion of the rotor of the first rotor-stator assembly, the air is pushed by the rotating rotor at 50 Revs/sec or more through an outlet 14 shown in FIGS. 12, 13 at e.g. 5 atmospheres depending on the dimensions of the components of the lifting unit.

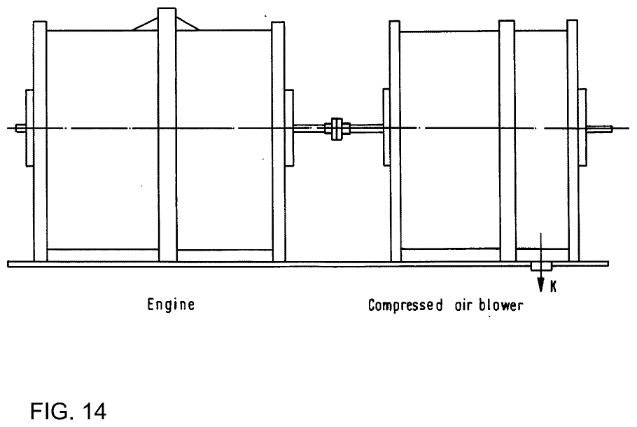

An example of a lifting device comprising a lifting unit is shown in FIG. 14. As can be taken from this figure, the lifting device comprises a lifting unit, which is driven by a rotor engine according to the invention, the lifting unit and the rotor engine rotating together by a common shaft. When the lifting device is mounted on a weight so that the air outlet is facing downwards, this can be lifted due to the air being pushed downwards.

According to another embodiment for more lifting power a lifting unit can comprise three rotor-stator assemblies instead of two which are arranged in the order first,-second, third assembly, the first and third assembly configured for sucking air and compressing air, and the second assembly having a smaller volume than the first and second assembly and being configured to further compress and blow out the air flowing from the first and third assembly, with a valve disc as disclosed herein between the first and the second and between the second and the third rotor-stator assembly, all rotor-stator assemblies rotating together by a common shaft and preferably driven by a rotor engine as described. The result is that from the air outlet of the second assembly more pressurized amount of air is blown continuously at very high speed that can lift very heavy weights.

1. A rotor-stator assembly for a rotary engine, compressor or pump, the rotor-stator assembly comprising:
a stator chamber (1, 2) having a peripheral wall with an inner surface;
a rotor (3, 4) arranged to rotate eccentrically in the stator chamber (1, 2), the rotor (3, 4) defining a receptacle and the rotor (3, 4) configured to provide a first fluid seal at a region of maximum proximity between an outer peripheral surface of the rotor (3, 4) and the inner surface of the peripheral wall of the stator chamber (1, 2);
bearings and slides along the inner surface of the stator chamber (1, 2); and
a component (15) rotating with the rotor and having a first end and a second end, the first end being permanently connected to the inner surface of the peripheral wall of the stator chamber (1, 2) by means of the bearings and slides, and the second end being accommodated in a radially movable manner in the receptacle of the rotor (3, 4);
wherein the first and second fluid seals delimit a first chamber portion and a second chamber portion of the stator chamber (1, 2).

2. The rotor-stator assembly according to claim 1, wherein sides of the component (15) are each connected as viewed axially to a vertical wreath, each wreath being configured to rotate by ball bearings on either inner side of the stator chamber (1, 2) or wherein the component (15) is slidingly connected to at least two ball bearing rims provided on the inner surface of the stator chamber and a sealing lip is arranged at the end of the component facing the inner surface of the stator chamber.

3. A rotor engine comprising a first and second rotor-stator assemblies according to claim 1, wherein:
the rotor (4, 3) of each rotor-stator assembly is mounted on a common main shaft (5) and arranged to rotate eccentrically each in the stator chamber (2, 1), whereby the stator chamber (2, 1) of each of the first and second rotor-stator assemblies are coaxially arranged and connected for fluid communication by means of a connecting fluid channel defined by two respective openings (11, 12) of the stator chambers (1,2), the connecting fluid channel being opened and closed by an opening (8) in a valve disc (7) located between the first and the second rotor-stator assembly and arranged to rotate with the main shaft (5);
the first rotor-stator assembly is configured such that its first chamber portion is for performing an intake part of a four-stroke engine cycle, and its second chamber portion is for performing a compression part of the four-stroke engine cycle; and
the second rotor-stator assembly is configured such that its first chamber portion is for performing a detonation part of a four-stroke engine cycle, and its second chamber portion is for performing an exhaust part of the four-stroke engine cycle, the rotor (3) of the second rotor-stator assembly and thus the component (15) thereof leads the rotor (4) of the first rotor-stator assembly and thus the component (15) thereof by an offset angle of approximately 90°, whereby the valve disc (7) opens the connecting fluid channel between the first and the second stator chamber when the compression in the second chamber portion of the first rotor-stator assembly has reached the maximum value.

4. The rotor engine according to claim 3, wherein:
the rotor engine is configured such that at the beginning of a revolution the first chamber portion of the first rotor-stator assembly has a minimal volume, whereby as the rotor (4) rotates, the increasing volume of the first chamber portion draws air in through an air intake channel (9) provided in the stator chamber (2), whereby at the same time, air drawn in during the previous revolution is compressed in the second chamber portion of the first rotor-stator assembly by the rotation of the rotor (4) and the component (15);
when the volume of the second chamber portion of the first rotor-stator assembly reaches a predetermined minimum value and thus a predetermined maximum compression is reached, the connecting fluid channel built by the two respective openings (11, 12) of the rotor-stator assemblies is opened by the valve disc (7), so that the compressed air passes through the connecting fluid channel to the first chamber portion (13) of the second rotor-stator assembly, which serves as a combustion chamber and subsequently;
when the connecting fluid channel is closed by the valve disc (7), due to the rotation thereof, fuel is sprayed or misted into the airflow by means of a at least one nozzle (29), whereby subsequently when the combustion chamber has reached a predetermined volume due to the rotation of the rotor (3) the compressed fuel-air mixture in the first chamber portion of the second rotor-stator assembly is detonated by an ignition spark or other suitable means (30), thereby providing drive force on the rotor (3) of the second rotor-stator assembly and thus on the common main shaft (5); and
the second chamber portion of the second rotor-stator assembly contains the exhaust gases from the previous detonation, which are then expelled through an exhaust channel (14) as the volume of the second chamber portion is reduced, so that after a complete revolution of the rotors a four-stroke engine cycle is completed.

5. A lifting unit comprising:
a main shaft (5);
a first and a second rotor-stator assembly according to claim 1, each rotor (4, 3) thereof being mounted on the main shaft (5) and arranged to rotate eccentrically in the stator chamber (2, 1), whereby the stator chamber (2, 1) of the first and second rotor-stator assemblies are coaxially arranged and connected for fluid communication by means of a connecting fluid channel defined by two respective openings (11, 12) of the stator chambers (1,2); and
a valve disc located between the first and the second rotor-stator assembly and arranged to rotate with the main shaft (5), wherein the connecting fluid channel is configured to be opened and closed by an opening (8) in a valve disc (7);
wherein the stator chamber (1) of the second rotor-stator assembly has a larger volume than the stator chamber (2) of the first rotor-stator assembly;
wherein the second rotor-stator assembly is configured to be driven by an engine and to be used for air intake into the first chamber portion thereof from an air inlet, and for compressing this
amount of air, the compressed air being transferred from the second chamber portion thereof to the first chamber portion of first rotor-stator assembly through the connecting fluid channel and the rotary disc valve when the openings coincide, when the lifting unit is in motion, the compressed air being pushed from the second chamber portion of the first rotor-stator assembly.

6. The lifting unit according to claim 5, wherein sides of the component (15) are each connected as viewed axially to a vertical wreath, each vertical wreath being configured to rotate by ball bearings on either inner side of the stator chamber (1, 2), or wherein the component (15) is slidingly connected to at least two ball bearing rims provided on the inner surface of the stator chamber and a sealing lip is arranged at the end of the component facing the inner surface of the stator chamber.

7. A lifting device comprising the lifting unit according to claim 5, wherein the lifting unit is driven by a rotor engine comprising:
a third and a fourth rotor-stator assemblies according to claim 1, the rotor (4, 3) of each rotor-stator assembly being mounted on the main shaft (5) and arranged to rotate eccentrically each in the stator chamber (2, 1), whereby the stator chamber (2, 1) of each of the third and fourth rotor-stator assemblies are coaxially arranged and connected for fluid communication by means of a connecting fluid channel defined by two respective openings (11, 12) of the stator chambers (1,2), the connecting fluid channel being opened and closed by an opening (8) in a valve disc (7) located between the third and the fourth rotor-stator assembly and arranged to rotate with the main shaft (5),
wherein the third rotor-stator assembly is configured such that its first chamber portion is for performing an intake part of a four-stroke engine cycle, and its second chamber portion is for performing a compression part of the four-stroke engine cycle,
wherein the fourth rotor-stator assembly is configured such that its first chamber portion is for performing a detonation part of a four-stroke engine cycle, and its second chamber portion is for performing an exhaust part of the four-stroke engine cycle,
wherein the rotor (3) of the fourth rotor-stator assembly and thus the component (15) thereof leads the rotor (4) of the third rotor-stator assembly and thus the component (15) thereof by an offset angle of approximately 90°, whereby the valve disc (7) opens the connecting fluid channel between the third and the fourth stator chamber when the compression in the fourth chamber portion of the first rotor-stator assembly has reached the maximum value;
wherein the lifting unit and the rotor engine are configured to rotate together by the main shaft (5).
